(19) United States
(12) Patent Application Publication
(10) Pub. No.: US 2006/0236593 A1
(43) Pub. Date: Oct. 26, 2006

(54) Candle refill kit and method of use

(76) Inventor: Daniel S. Cap, Streamwood, IL (US)

Correspondence Address: Maxwell J. Petersen;Pauley Petersen & Erickson, Suite 365, 2800 West Higgins Road, Hoffman Estates, IL, 60195, US

(21) Appl. No.: 11/111,026

(22) Filed: Apr. 21, 2005

(51) Int. Cl. C11C 5/00

(52) U.S. Cl. 44/275

(57) ABSTRACT

A candle refill kit useful for preparing home made candles includes a disposable microwaveable container and a microwaveable candlewax composition. The candlewax composition is microwave heated in the microwaveable container to an elevated temperature sufficient to initiate pouring of the candlewax composition. The candlewax composition is then poured from the microwaveable container into a candle mold (to make a stand-alone candle) or a candle container (to make a container candle).

### FIELD OF THE INVENTION

This invention is directed to a candle refill kit which can be used to make a candle in as little as two steps, and a corresponding method of use.

### BACKGROUND OF THE INVENTION

Candlemaking by individuals is a hobby that requires skill, time and precision. Conventional candlemaking kits for making paraffin wax-based and other candles include separate quantities of various wax ingredients, oils, scenting agents, coloring agents and the like. The individual candlemaker slowly heats the wax ingredients in a double boiler, on a conventional stove to a carefully selected temperature, adds and mixes the remaining ingredients at selected time intervals, then pours the resulting mixture into individual containers (for container candles) or molds (for stand-alone candles). Failure to carefully follow the procedures can result in candles with uneven color, inadequate scent, uneven burning and/or undesirable appearance. Overheating, or uneven heating, can result in burns, fires, and related hazards.

One example of a candlewax commercially sold for candle kits is a 10-lb slab of paraffin wax mixed with color and fragrance, sold by Endless Possibilities of Oklahoma City, Okla. under the trade name CRAFTY CANDLES. This wax must be melted in a boil bag or double boiler before being poured into a candle mold, jar or container. Accidental overheating can result in fire.

While candlemaking by individuals is less expensive than purchasing ready-made candles, many individuals practice candlemaking primarily for enjoyment and fun. Others seek to minimize the cost of obtaining candles without spending substantial time and effort. Thus, there is a demand for candle kits which are simpler and safer to use.

U.S. Pat. No. 3,744,956, issued to Hess, discloses a candlemaking kit including shaped slugs of wax having different colors. The shaped slugs of wax are inserted into a container equipped with a wick. Molten wax is then poured into the container to fill the spaces between the wax slugs, wick and container wall.

U.S. Pat. No. 4,855,098, issued to Taylor, discloses a method of forming candles from hard, pre-formed pieces of paraffin wax composition. The pre-formed wax pieces are submerged in water at 100-120° F. to soften the wax. The wax pieces are removed from the water, and are combined with a wick and each other while still soft, to make a candle.

One feature often associated with simplified candlemaking kits is that the candles thus formed are obviously different from most other candles. The simplified kits often do not result in candles having a solid, uniform appearance. There is thus a need for a candlemaking kit which, with minor effort, can be used to make candles that are visually indistinguishable from factory made candles purchased in stores, and from home made candles made using more elaborate techniques.

### SUMMARY OF THE INVENTION

The present invention is directed to a candle refill kit and associated method of making candles. The candle refill kit includes a disposable microwaveable container and a microwaveable candlewax composition.

In one embodiment, the candle refill kit includes a disposable microwaveable container, a measured amount of microwaveable candlewax composition in the container and one or more wicks. The wicks can be properly selected and/or engineered for compatible burning with the wax composition. The disposable microwaveable container may contain enough candlewax composition to make one candle of a predetermined size, or may contain enough candlewax composition to make a predetermined number of candles. The candlewax composition may include all of the candlewax ingredients blended together, and includes all of the essential ingredients of a candle except for a wick and (where applicable) a candle container. Alternatively, scenting agents and/or coloring agents may be provided in one or more separate packets.

To use the kit, the candlemaker heats the disposable microwaveable container including the candlewax composition in a microwave oven for a time sufficient to melt the candlewax composition. The molten candlewax composition is then poured into one or more candle molds, each equipped with a wick (to make stand-alone candles) or one of more candle containers, each equipped with a wick (to make container candles). Separate packets of scenting and/or coloring agents may be added to the candlewax and mixed before or after the molten wax is poured. The resulting candles have a uniform appearance and composition, similar to or better than factory-made candles purchased in stores, and home made candles made using more complex conventional methods.

In another embodiment, the candle refill kit includes a disposable microwaveable container and a measured amount of microwaveable candlewax composition in a solid form separate from the container. The measured amount of candlewax composition may be enough to make just one candle, or a predetermined number of candles, and may be in a packet. The candlewax composition includes all of the candlewax ingredients blended together. Alternatively, scenting agents and/or coloring agents may be provided in one or more separate packets. To use the kit, the candlemaker transfers the solid candlewax composition into the disposable microwaveable container, and then follows the method steps described for using the first embodiment of the candle refill kit.

The features and advantages of the candle refill kit using microwaveable candlewax may include some or all of the following. First, the microwaveable candlewax is easier and safer to process than conventional paraffin wax which requires a stove-top double boiler. Paraffin wax is subject to ignition when overheated. Second, making candles from the candle refill kit is less expensive than purchasing new candles. Third, candles made using the candle refill kit may be of higher quality than stove-top formed and store-bought candles.

Fourth, the microwaveable candlewax can be formed using renewable resources, such as vegetable waxes. Fifth, microwaveable candlewax compositions including vegetable wax are easier to clean from hard surfaces, clothing and skin than paraffin wax, and can typically be removed using soap and water. Sixth, the candle refill kit provides a simplified candlemaking process using pre-measured amounts of various candlewax ingredients. The emotional fulfillment of making one's own quality candles can thus be experienced by a larger number of people.

The foregoing and other features and advantages of the invention will become further apparent from the following detailed description.

### BRIEF DESCRIPTION OF THE DRAWINGS

FIG. 1 is a perspective view of a first embodiment of a candle refill kit of the invention.

FIG. 2 is a perspective view of a second embodiment of a candle refill kit of the invention.

FIG. 3 illustrates the candle refill kit of FIG. 1 with a particularly suitable lid and vented cover.

### DEFINITIONS

As used herein, the term “plant-based wax” refers to a plant-based substance which has a solid, wax-like consistency at ambient conditions (22° C., 50% relative humidity). The term includes vegetable oils which have been partially or fully hydrogenated or fractionated to generate a solid, wax-like consistency, and plant-based substances such as carnauba wax and candelilla wax which have a solid, wax-like consistency without requiring hydrogenation.

As used herein, the term “paraffin-based wax” refers to waxes derived from a class of all aliphatic hydrocarbons characterized by a straight or branched hydrocarbon chain, having a molecular formula CₙH₂ₙ₊₂, and a high enough molecular weight to produce a melting point of about 40-65° C. Paraffin waxes also have a solid, wax-like consistency at ambient conditions (22° C., 50% relative humidity). Paraffin waxes typically include a mixture of high molecular weight aliphatic hydrocarbons, which mixture possesses these properties.

As used herein, “hydrogenated vegetable oil” encompasses partially and fully hydrogenated vegetable oils.

As used herein, “vegetable oil” includes any plant-based oil. Vegetable oils may be naturally occurring or processed, and may be solid or liquid at ambient conditions (72° F., 50% relative humidity). The term includes plant-based oils whose carbon-carbon double bonds are unsaturated, partially or fully saturated.

As used herein, “partially hydrogenated vegetable oil” includes any plant-based oil which has been partially hydrogenated. The term “partially hydrogenated vegetable oil” also includes mixtures of partially hydrogenated vegetable oil and fully hydrogenated vegetable oil. Such mixtures are by definition, partially hydrogenated with an intermediate level of hydrogenation. Similarly, the term “partially hydrogenated vegetable oil” includes mixtures of partially hydrogenated vegetable oil and vegetable oil which has not been hydrogenated, and mixtures of fully hydrogenated and unhydrogenated vegetable oil.

As used herein, “fully hydrogenated vegetable oil” includes any plant-based oil which has been fully hydrogenated. Fully hydrogenated vegetable oils typically have iodine values between zero and five.

As used herein, “fractionated vegetable oil” includes any vegetable oil which has been processed by fractionation. Fractionation removes the solid, wax-like components from the liquid components of vegetable oil by controlled crystallization and separation. Fractionation techniques may involve the use of solvents or dry processing.

As used herein, “lipid” is an inclusive term for fats and fat-derived materials. It includes all substances that are 1) relatively insoluble in water but soluble in organic solvents, 2) related either actually or potentially to fatty acid esters, fatty alcohols, sterols, waxes, etc., and 3) utilizable by animal organisms.

As used herein, “iodine value” is the number of grams of iodine that an unsaturated compound or blend will absorb in a given time under arbitrary conditions. A low iodine value implies a high level of saturation, and vice versa. The iodine value can be determined by the WIIS method of the American Oil Chemists' Society (A.O.C.S. Cd 1-25).

As used herein, “coloring agent” refers to conventional dyes, pigments, and other ingredients whose purpose is to impart color to a candlewax composition.

As used herein, “scenting agent” refers to any additive for a candlewax composition which is intended to release a selected aroma prior to or during burning of a candle made from the candlewax composition. Examples of scenting agents include without limitation scented oils, essential oils and other liquid fragrances.

### DETAILED DESCRIPTION OF THE PRESENTLY PREFERRED EMBODIMENTS

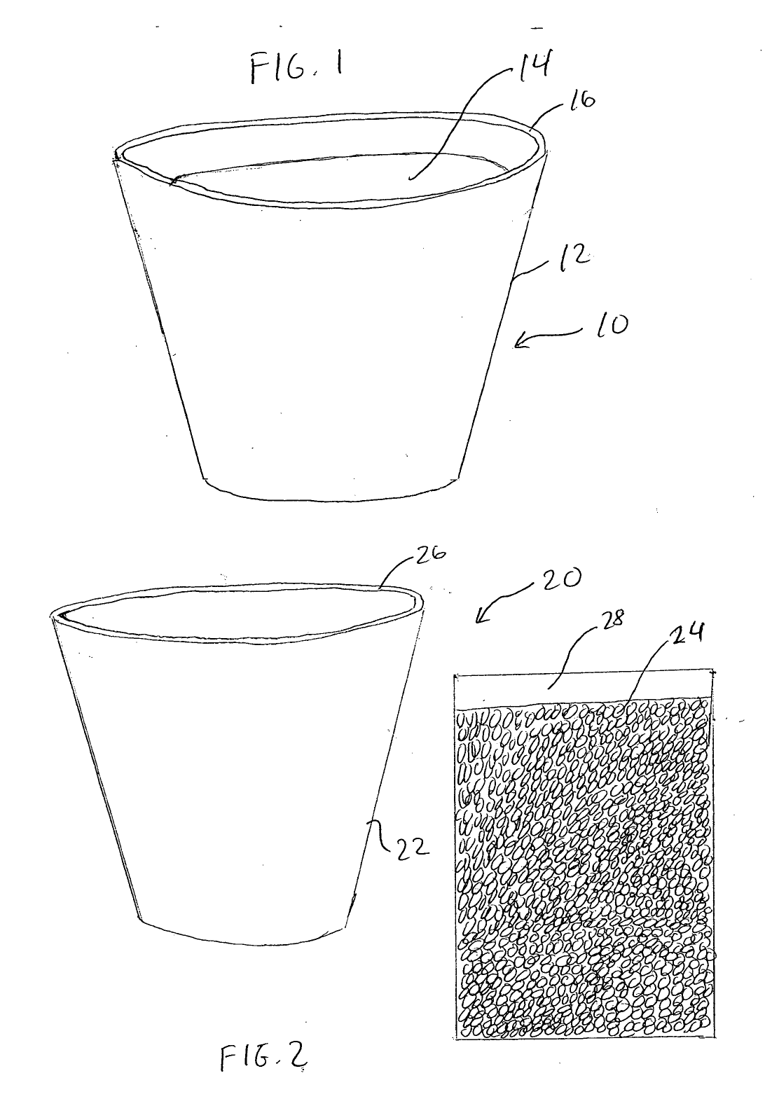

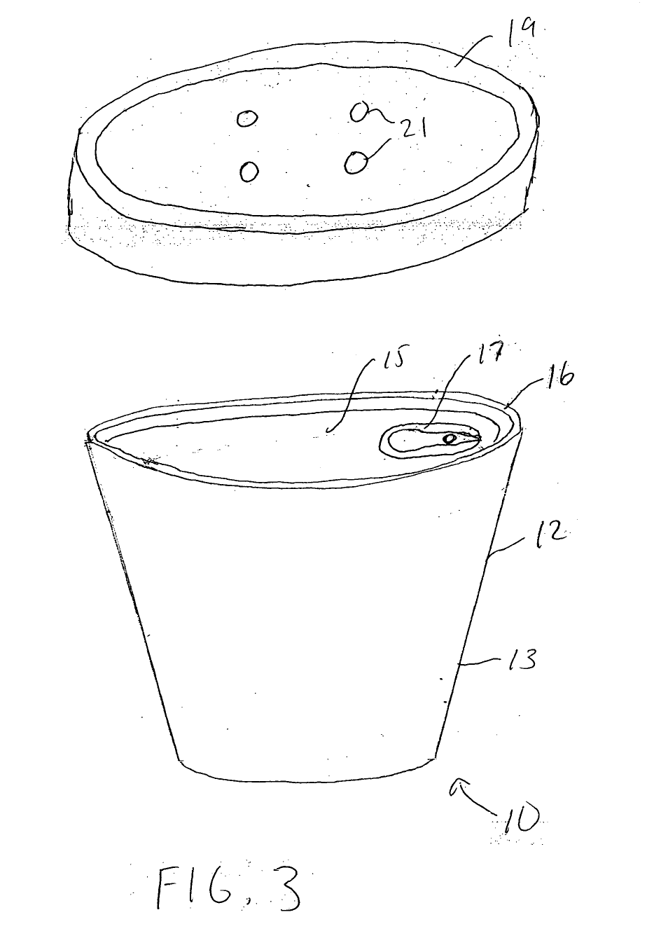

FIG. 1 illustrates a candle refill kit 10 of the invention which includes a disposable microwaveable container 12 and a predetermined amount of microwaveable candlewax composition 14 in the container 12. FIG. 2 illustrates a candle refill kit 20 of the invention which includes a disposable microwaveable container 22 and a predetermined amount of granules, flakes, beads or pastilles (collectively “particles”) of microwaveable candlewax composition 24 in a plastic bag 28 or other packet separate from the container 22.

One feature which makes the invention possible is the use of a microwaveable candlewax composition. The phrase “microwaveable candlewax composition” refers to a candlewax composition whose ingredients can be substantially transformed (preferably, entirely transformed) from a solid state to a molten state in a microwave oven. Conventional (i.e., non-microwaveable) candlewax compositions include primary amounts of paraffin wax ingredients. Paraffin waxes are typically not responsive to microwaves, and generally do not melt in a microwave oven. In one embodiment of the invention, the candlewax composition includes an operable amount of microwaveable ingredients in addition to paraffin wax, such that heating of the microwaveable ingredients in turn melts the paraffin wax. Alternatively, a non-conventional, microwaveable paraffin wax can be used.

Candlewax compositions useful in the kit of the invention should include enough microwaveable ingredients to melt remaining ingredients. The composition may include about 25-100% by weight microwaveable ingredients, or about 50-100% by weight microwaveable ingredients, or about 75-100% by weight microwaveable ingredients, or about 90-100% by weight microwaveable ingredients. “Microwaveable ingredients” include ingredients which can be transformed from a solid state to a molten state due to interaction with, and heating by microwaves, as well as ingredients which exist in a liquid state at ambient temperature, and are heated by microwaves. The amount of microwaveable ingredients should be high enough that the candlewax composition as a whole behaves as a microwaveable candlewax composition, meaning that it transforms to a molten state in a microwave oven. This means that essentially all of the candlewax ingredients melt either a) due to interaction with, and heating by microwaves, or b) due to interaction with other ingredients which, in turn, are heated by microwaves.

Microwaveable candlewax compositions include without limitation waxes and wax ingredients based on lipids. Lipids, as described below, are typically microwaveable. Examples of waxes based on lipids include plant-based waxes and animal-based waxes. These materials include any plant-based or animal-based substance which has a solid, wax-like consistency at ambient conditions. The lipid-based wax may have an iodine value of about 0-150.

Examples of plant-based waxes include plant-based substances such as carnauba wax, candelilla wax and rice bran wax which have a wax-like consistency without requiring hydrogenation. Examples also include palm wax, cocoa butter, coconut oil, and all oils having a naturally high degree of saturation. Other examples include partially and fully hydrogenated vegetable oils (collectively “hydrogenated vegetable oils”) having an iodine value of about 0-100, suitably about 10-90, particularly about 15-80 and desirably about 20-75. A fully-hydrogenated vegetable oil may have an iodine value of about 0-5. Generally, the melting point of a vegetable oil increases as the level of hydrogenation increases and the iodine value decreases. The hydrogenation process adds hydrogen atoms to the carbon-carbon double bonds in unsaturated fatty acids. In addition to higher melting points, hydrogenation leads to higher solid fat content and longer shelf life. Partially hydrogenated vegetable oils typically have a higher iodine value, and are useful in applications (e.g., container candles) where lower melting points are desired.

The plant-based wax can also be a fractionated vegetable oil. Fractionation removes the solid, wax-like components from the liquid components of vegetable oil by controlled crystallization and separation. Fractionation techniques involve the use of solvents or dry processing. The effect of hydrogenation or fractionation is to provide a vegetable oil with a sufficiently high degree of saturation to perform as a wax having a desired melting point and other properties.

The hydrogenated or fractionated vegetable oil can be derived from any plant-based oil. Examples include without limitation cottonseed oil, sunflower oil, canola oil, peanut oil, soybean oil, safflower oil, corn oil, palm oil, olive oil, coconut oil, palm kernel oil, almond oil, jojoba oil, avocado oil, sesame oil, castor oil, and combinations thereof. The hydrogenated or fractionated vegetable oil may be derived from one or more vegetable oils having the same or different levels of saturation. Vegetable oils derived from natural sources typically include one or more triglycerides as a major component, lesser amounts of diglycerides and monoglycerides, and very minor amounts of free fatty acids. A triglyceride is an ester compound of glycerol linked to three fatty acids, and has the following general formula: 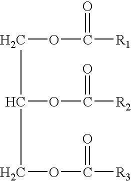
wherein R₁, R₂ and R₃ are fatty acid chains and may be the same or different.

A diglyceride is an ester compound of glycerol linked to two fatty acid chains. A monoglyceride is an ester composed of glycerol linked to one fatty acid chain. A free fatty acid is an unattached fatty acid in a vegetable oil, most commonly stearic acid and/or palmitic acid.

The hydrogenated vegetable oil can be partially or fully hydrogenated using known techniques for chemically adding hydrogen gas to a liquid vegetable oil in the presence of a catalyst. The process converts some or all of the unsaturated carbon-carbon double bonds in the vegetable oil molecules to single carbon-carbon bonds, thereby increasing the level of saturation. The degree of hydrogenation reflects the total number of double bonds which are converted. The hydrogenation may cause partial or total saturation of the double bonds in any of the vegetable oil components, including triglycerides, diglycerides, monoglycerides and free fatty acids. Partial hydrogenation may relocate some of the double bonds to new locations, e.g., from a cis isomeric configuration to a trans isomeric configuration. Sufficient hydrogenation typically causes the vegetable oil to assume a solid or semi-solid state at ambient temperature (e.g., 22° C.).

The lipid-based wax may be an acetylated plant-based wax. Acetylated plant-based waxes are described in co-pending U.S. patent application Ser. No. 10/964,081, filed 13 Oct. 2004, the disclosure of which is incorporated by reference.

The lipid-based wax composition may contain about 0-100% plant-based wax, suitably at least about 25% by weight plant-based wax, suitably about 50-98% by weight or about 60-95% by weight, or about 70-90% by weight, or about 60-80% by weight.

The lipid-based wax composition may also contain one or more polyol fatty acid partial ester components. Polyols which can be used to form the fatty acid partial esters include at least two and, preferably, at least three hydroxy groups per molecule (also referred to as “polyhydric alcohols”). Typically, the polyols have no more than 6 hydroxy groups per molecule and include up to 10 carbon atoms and more commonly no more than 6 carbon atoms. Examples of suitable aliphatic polyols include glycerol, alkylene glycols (e.g., ethylene glycol, diethylene glycol, triethylene glycol and neopentylglycol), pentaerythritol, trimethylolethane, trimethylolpropane, sorbitan and sorbitol. Suitable alicyclic polyols include cyclohexanediols and inositol as well as natural cyclic polyols such as glucose, galactose and sorbose.

The polyol partial esters have one or more unesterified hydroxyl groups with the remaining hydroxy groups esterified by a fatty acyl group. The fatty acyl groups (“C(O)R”) in the partial esters include an aliphatic chain (linear or branched) and typically have from 14 to 30 carbon atoms.

Fatty acid partial esters of polyols which include no more than about 6 carbon atoms and have three to six hydroxy groups per molecule, such as glycerol, pentaerythritol, trimethylolethane, trimethylolpropane, sorbitol, sorbitan, inositol, glucose, galactose, and/or sorbose, are suitable. Glycerol and/or sorbitan partial esters are examples of polyol partial esters.

Fatty acid monoesters of polyols are suitable for use. Suitable examples include glycerol monoesters, e.g., glycerol monostearate, glycerol monopalmitate, and/or glycerol monooleate, and/or sorbitan monoesters, e.g., sorbitan monostearate, sorbitan monopalmitate, and/or sorbitan monooleate. Monoesters which are produced by partial esterification of a polyol with a mixture of fatty acids derived from hydrolysis of a triacylglycerol stock are also suitable. Examples include monoglycerol esters of a mixture of fatty acids derived from hydrdolysis of a partially or fully hydrogenated vegetable oil, e.g., fatty acids derived from hydrolysis of fully hydrogenated soybean oil.

Propylene glycol monoesters are particularly suitable for use in lipid-based wax compositions according to the invention. Monoglycerides and diglycerides are also suitable. Other examples of suitable polyol fatty acid partial esters include without limitation di- and/or triesters of higher polyols, e.g., di- and/or triesters of a polyol having 5 hydroxy groups, such as sorbitan. For example, the lipid-based wax composition may include one or more sorbitan triesters of fatty acids having 16 to 18 carbon atoms, e.g., sorbitan tristearate, sorbitan tripalmitate, sorbitan trioleate, and mixtures including one or more of these triesters.

The polyol fatty acid partial acid ester component may constitute about 0-100% by weight of the lipid-based candlewax composition, suitably about 1-50% by weight, or about 10-35% by weight, or about 20-30% by weight.

The lipid-based candlewax composition may also include one or more free fatty acids. Examples of free fatty acids include without limitation lauric acid, myristic acid, palmitic acid, stearic acid, arachidic acid, palmitoleic acid, oleic acid, gadoleic acid, linoleic acid, linolenic acid and combinations thereof. When used, the free fatty acid component may constitute about 1-50% by weight of the plant-based candlewax composition, suitably about 3-25% by weight, or about 5-10% by weight.

The lipid-based wax composition may also include a scenting agent in an amount of about 0.1-15% by weight, suitably about 1-10% by weight, or about 2-6% by weight. Examples of scenting agents include without limitation scented oils such as sandalwood oil, civet oil, cedarwood oil, patchouli oil, bergamot oil, germanium oil, rose oil, citronella oil, and the like. Other liquid scenting agents include without limitation eugenol, geraniol, geranyl acetate, isoeugenol, isobornyl acetate, linalyl acetate, linalool, methyl ethyl ketone, methylionone, phenylethyl alcohol, and various other compounds of aldehydes, ketones, esters, alcohols, terpenes or the like. The scenting agent may be an insect repellent such as citronellal or a therapeutic agent such as menthol or eucalyptus.

The lipid-based wax composition may also include other optimal wax ingredients, including without limitation, beeswax, montan wax, paraffin wax, and other conventional waxes. When used, these other wax ingredients typically do not constitute more than about 25% of the plant-based wax composition. Conventional dyes, pigments and other coloring agents may be added at up to about 8% by weight, suitably about 0.1-3% by weight.

The lipid-based wax composition may be composed of ingredients selected to provide a melting point of about 35-65° C., suitably about 40-55° C. The ingredients of the wax composition can be added individually or together to a melt blender and mixed at about 50-95° C., suitably about 55-80° C. until a uniform wax composition is obtained. Any conventional mixing equipment can be employed. The resulting plant-based wax composition is useful in a variety of candles.

The microwaveable candlewax composition may also include ingredients which are not independently microwaveable, but which melt in a microwave oven due to the presence of microwaveable ingredients. Ingredients which are not independently microwaveable may constitute about 0-75% by weight of the microwaveable candlewax composition, suitably no more than about 50% by weight, or no more than about 25% by weight, or no more than about 10% by weight, or substantially 0% by weight. Ingredients which are not independently microwaveable do not absorb microwave energy. Such ingredients include without limitation conventional paraffin waxes having an average carbon number of about 18-40, suitably about 22-36. These ingredients can be melted in a microwave oven by means of conductive heat transfer by other ingredients which absorb and are heated by microwaves. Thus, the inclusion of nonmicrowaveable ingredient(s) in the candlewax composition is contingent upon the presence of enough microwaveable ingredient(s) to render the overall candlewax composition microwaveable.

The term “disposable microwaveable container” refers generally to any relatively inexpensive container which can be discarded or recycled after a single use, and which can be used for heating and holding molten candlewax having a temperature of at least about 35° C., suitably about 50-95° C., particularly about 55-80° C. The disposable microwaveable container may be formed of a relatively inexpensive thermoplastic polymer having a melting point of at least about 105° C., which is significantly higher than the highest temperature achieved by molten candlewax in the container. Suitable thermoplastic materials include without limitation polypropylene, high density polyethylene, medium density polyethylene, linear low density polyethylene, branched low density polyethylene, some other polyolefin homopolymers and copolymers and other plastic materials. If the melting temperature of the disposable container is too low, or too close to the highest temperature achieved by the molten candlewax, the container may rupture and/or melt during heating of the candlewax in the disposable container.

Other disposable container materials can also be used, but are less preferred. Certain paper containers may contain the molten wax. However, paper containers are less sturdy and may not have sufficient insulative properties to prevent user discomfort when the container holding the molten wax is lifted. Disposable glass containers may be used. Disposable metal containers are more expensive, and may reflect or otherwise interfere with the microwaves.

The disposable microwaveable container may have a rectangular, cylindrical or semi-conical configuration, or another suitable shape. The disposable containers 12 and 22 illustrated in FIGS. 1 and 2 have a semi-conical cup-like configuration. The container walls 16 and 26 should be thick enough and sturdy enough to provide a rigid container with minimal bending when the container is lifted, and to insulate a user's hand from molten wax within the disposable container. Depending on the size of the disposable container, the container wall(s) may have a thickness of about 0.025 inch to about 0.250 inch, suitably about 0.050 inch to about 0.150 inch. Alternatively, the container may be in the form of a flexible bag.

In order to minimize unwanted spilling of molten wax, the disposable microwaveable container should have an internal volume which is about 10-20% larger than the volume of wax within the container. The size of the disposable microwaveable container may vary depending on the size and number of candle(s) to be made from the wax in the disposable container. Also, the disposable microwaveable container should not be so small or so large that handling the disposable container or pouring the molten wax becomes difficult. For instance, the disposable microwaveable container may have an internal volume of about 2 ounces to about 32 ounces, suitably about 4 ounces to about 16 ounces. Each wax-filled disposable container can be used to make from 1-20 candles, suitably from 1-10 candles, particularly from 1-4 candles.

In one embodiment, the disposable microwaveable container 12 may be configured as illustrated in FIG. 3, with a lower cup portion 13, a removable sealed lid 15 formed of plastic or metal, and a pop-up tab 17 anchored to the sealed lid 15. A removable plastic outer cover 19 having openings 21 initially covers the sealed lid 15. When the candle refill kit is used, the outer cover 19 is temporarily removed and the sealed lid 15 is peeled away from the pre-filled container 12 with the aid of pop-up tab 17. The outer cover 19 is then re-installed. When the microwaveable container 12 is being heated, the openings 21 prevent pressure build-up in the container by allowing minimal escape of vapors. The outer cover 19 prevents boil-over of the wax composition while retaining most of any scenting agents within the container 12.

The candle refill kit of the invention may also include one or more wicks which are selected and/or engineered for compatible burning with the microwaveable candlewax composition. Various wicks are known in the art, and are designed for use with particular types of candlewax. When the candlewax composition is a lipid-based wax composition as described above, the wick may be a flat-braided wick known in the art as “HTP” or “ECO”, or a square-braided wick known in the art as “CD”, or “RRD”. The wick is typically provided separate from the microwaveable candlewax composition.

To make the candle refill kit 10 illustrated in FIG. 1, the ingredients of the microwaveable candlewax composition 14 are mixed using conventional methods to form a uniform molten blend or slurry. One or more disposable microwaveable containers 12 are separately formed or provided. The molten candlewax composition is then poured into individual disposable containers 12 and permitted or caused to cool and harden. For the candlewax compositions based on lipid-based waxes, described above, the ingredients should be mixed at about 50° C. or greater, suitably about 50-95° C., particularly about 55-80° C. The initial mixing step can be performed using any suitable batch or continuous mixer, including without limitation a Hobart mixer or a stirred kettle equipped with a steam heat exchanger. The amount of molten candlewax poured into each disposable container 12 can be precisely controlled according to a predetermined amount by monitoring the weight of the filled container or the depth of the candlewax fill.

In an alternative embodiment, the molten candlewax blend may be prepared at a first temperature of at least about 50° C., suitably about 50-95° C., particularly about 55-80° C. Then, the molten blend is rapidly cooled to a second (sub-molten) temperature less than about 50° C., suitably about 25-40° C., particularly about 30-38° C., and is slowly agitated at the second temperature to form a slurry or magma of fine wax crystals. The mild agitation should occur for a long enough time period to homogenize the slurry or magma, and to achieve a uniform and stable crystal form. The slurry or magma (at the second temperature) can then be poured into the disposable containers 12, and permitted to cool and harden. Candles made by this technique have more uniform crystallization and burning properties, and better retention of scenting agents and other volatile ingredients.

Rapid cooling of the molten candlewax from the first temperature to the second temperature can be accomplished by passing the candlewax through a swept-surface heat exchanger. A suitable swept-surface heat exchanger is a commercially available Votator A Unit, described in more detail in U.S. Pat. No. 3,011,896, which is incorporated by reference. A Votator A Unit includes an internally refrigerated, elongated cylinder equipped with a sweeping device. Molten wax enters the unit and quickly forms crystals, which are continuously removed from the cylinder walls. Cooling can be provided by feeding a suitable cooling fluid, such as expanding ammonia, through a jacket surrounding the cylinder.

The chilled candlewax composition can then be passed to a holding tank equipped with an agitation mechanism, for mildly agitating and working the composition at about the second temperature until a candlewax composition having the desired consistency, crystal stability and homogeneity is obtained. A suitable holding tank for agitating the composition is a Votator B Unit, also described in U.S. Pat. No. 3,011,896. The Votator B Unit is an elongated cylindrical chamber in series with the Votator A Unit. The Votator B Unit includes a rotating shaft having projecting fingers intermeshing with stationary fingers projecting from the inner cylinder wall, to provide agitation. Crystal formation and modification occur under virtually adiabatic conditions in the Votator B Unit.

The Votator A and Votator B Units can be formed of stainless steel, with inlets and outlets at their bases. The units are further described in U.S. Pat. No. 1,783,864 and U.S. Reissue Pat. No. 21,406, which are incorporated by reference. The rapid cooling followed by mild agitation described above are collectively referred to as “votating” the candlewax composition. The composition thus formed is a “votated” candlewax composition.

To prepare a candle using the candle refill kit 10 illustrated in FIG. 1, the disposable microwaveable container 12 filled with candlewax composition 14 is placed into a microwave oven and heated to a temperature sufficient to initiate pouring of the candlewax composition. If the candlewax composition 14 was added to the microwaveable container 12 in the molten state, then the candlewax will require heating to a molten temperature of at least about 40° C., suitably about 50-95° C., particularly about 55-80° C. before pouring can be initiated. In the embodiment illustrated in FIG. 3, the container 12 is initially pre-filled with a microwaveable candlewax composition and sealed closed with lid 15. The user needs only to open and remove lid 15 using pop-up tab 17, and install outer cover 19 before placing the container 12 in a microwave oven. The openings 21 in cover 19 prevent pressure build-up, while cover 19 prevents boil-over and excessive escape of scenting agents.

The candle refill kit 10 preferably includes specific microwaving instructions for obtaining a pourable candlewax composition. Required microwave times are typically not more than about five minutes, but may vary from less than one minute to 10 minutes or more depending on the volume of candlewax composition 14, the melting point of the candlewax composition 14, whether or not the candlewax composition was votated, and the size and heating power of the microwave oven. Because microwave heating times are much shorter than heating times previously required in conventional ovens, there is minimal escape of scenting agents or other volatile ingredients, and minimal degradation of temperature-sensitive ingredients, and increased safety. For this reason, it is permissible to heat all of the candlewax ingredients together in the microwave oven for the same length of time. The complex techniques of separate addition and blending of ingredients, associated with the longer heating times of conventional stoves with double boilers are thus avoided.

In one embodiment, the coloring agent(s), scenting agent(s) or both are provided in one or more separate packets. The microwaveable candlewax composition 14 in container 12 is heated to a molten state. The coloring and/or scenting agents are then added and mixed into the candlewax composition 14. This approach is beneficial because it minimizes the escape of scenting agents due to heating, and minimizes the discoloration of coloring agents.

To make a stand-alone candle, the molten candlewax composition 14 is poured from container 12 into a conventional candle mold equipped with a standing wick, and is cooled or permitted to cool. The resulting candle is released from the mold. To make a container candle, the molten candlewax composition 14 is poured into a candle container equipped with a standing wick, and is cooled or permitted to cool, forming the candle. This enables the use of attractive candle containers, which are new or which have previously been used. In either case, the wick should be centered and maintained upright while the wax composition is being poured. Once the microwaveable candlewax composition 14 has been poured, the disposable microwaveable container 12 can be discarded or recycled. The candle refill kit 10 of the invention is useful as a refill kit for all candle containers.

To make the candle refill kit 20, illustrated in FIG. 2, the ingredients of candlewax composition 24 are first melted and blended to form a uniform composition, using a conventional technique as described above for candlewax composition 14. One or more disposable microwaveable containers 22 are separately formed or provided. Then, in one embodiment, the molten candlewax composition is cooled, hardened and formed into granules, flakes, beads or pastilles (collectively “particles”). A predetermined volume or weight of candlewax composition, sufficient to fill a disposable container 22 to a desired level, is deposited and stored in a separate packet 28 which can be formed of plastic film or paper. In another embodiment, the molten candlewax composition is instead formed into slugs of predetermined volume or weight. A candlewax slug is cooled, deposited and stored in the packet 28. In still another embodiment, the molten candlewax composition 24 is rapidly cooled to a second temperature and votated as described above for candlewax composition 14. The magmna or slurry of votated candlewax composition 24 is poured, in a predetermined amount, into packet 28 for storage. The votated composition then cools and hardens into a slug. In any of these embodiments, the coloring and/or scenting agents may alternatively be provided in one or more separate packets as described above.

To prepare a candle using the candle refill kit 20 illustrated in FIG. 2, the user opens the packet 28 and transfers the particles or slug of candlewax composition 24 into the disposable microwaveable container 22. From that point forward, the method steps for preparing a candle using kit 20 are identical to the method steps for preparing a candle using kit 10, described above. The disposable microwaveable container 22 filled with candlewax composition 24 is heated in a microwave oven and then poured into a candle mold or candle container equipped with a standing wick. If the candlewax composition 24 was solidified from a molten state before being stored in packet 28, then it should be heated back to the molten state in the microwave oven before being poured from the disposable container 22. If the coloring and/or scenting agents are provided in separate packets, they can then be added and mixed with the molten candlewax composition 14.

In one embodiment, the microwaveable candle container 12 or 22 can be provided with a color-changing strip (not shown) on an internal surface, which changes color when the candlewax composition 14 or 24 reaches a desired temperature in the container. If the container 12 is transparent, the color-changing strip will advise the user when the candlewax composition 14 is sufficiently heated.

While the embodiments of the invention described herein are presently preferred, various modifications and improvements can be made without departing from the spirit and scope of the invention. The scope of the invention is indicated by the appended claims, and all changes that fall within the meaning and range of equivalents are intended to be embraced therein.

I claim:

1. A candle refill kit, comprising:
a disposable microwaveable container;
a microwaveable candlewax composition.

2. The candle refill kit of claim 1, wherein the disposable microwaveable container comprises a thermoplastic polymer.

3. The candle refill kit of claim 1, wherein the disposable microwaveable container comprises glass.

4. The candle refill kit of claim 1, wherein the disposable microwaveable container comprises paper.

5. The candle refill kit of claim 1, wherein the disposable microwaveable container comprises a cup portion and a cover with openings.

6. The candle refill kit of claim 5, wherein the disposable microwaveable container further comprises a sealed lid.

7. The candle refill kit of claim 2, wherein the thermoplastic polymer comprises a polyolefin having a melting point of at least about 105° C.

8. The candle refill kit of claim 1, wherein the microwaveable candlewax composition comprises a lipid-based wax.

9. The candle refill kit of claim 1, wherein the microwaveable candlewax composition comprises:
at least about 25% by weight of a plant-based wax;
about 1-50% by weight of a polyol fatty acid partial ester;
about 1-50% by weight of a free fatty acid;
about 0.1-15% by weight of a scenting agent; and
about 0-8% by weight of a coloring agent.

10. The candle refill kit of claim 9, wherein the microwaveable candlewax composition comprises:
about 50-98% by weight of the plant-based wax; and
about 10-35% by weight of the polyol fatty aid partial ester.

11. The candle refill kit of claim 9, wherein the polyol fatty acid partial ester comprises a propylene glycol monoglyceride.

12. The candle refill kit of claim 9, wherein the microwaveable candlewax composition comprises about 3-25% by weight of the free fatty acid.

13. The candle refill kit of claim 1, wherein the microwaveable candlewax composition comprises an acetylated wax.

14. The candle refill kit of claim 1, wherein the microwaveable candlewax composition comprises about 25-100% by weight microwaveable ingredients.

15. The candle refill kit of claim 1, wherein the microwaveable candlewax composition is votated.

16. The candle refill kit of claim 1, wherein the microwaveable candlewax composition comprises about 50-100% by weight microwaveable candlewax ingredients.

17. The candle refill kit of claim 1, wherein the microwaveable candlewax composition is inside the disposable microwaveable container.

18. The candle refill kit of claim 1, further comprising a packet, wherein the microwaveable candlewax composition is in the packet.

19. The candle refill kit of claim 17, wherein coloring and/or scenting agents are provided in one or more separate packets.

20. The candle refill kit of claim 1, wherein the disposable microwaveable container is rigid.

21. The candle refill kit of claim 19, wherein the disposable microwaveable container comprises a cup.

22. The candle refill kit of claim 1, wherein the disposable microwaveable container has a volume of about 2-32 ounces.

23. The candle refill kit of claim 1, wherein the disposable microwaveable container has a volume of about 4-16 ounces.

24. A candle refill kit, comprising:
a rigid disposable microwaveable container comprising a thermoplastic material and having a volume of about 2-32 ounces; and
a microwaveable candlewax composition comprising about 25-100% by weight microwaveable candlewax ingredients.

25. The candle refill kit of claim 24, wherein the microwaveable candlewax composition comprises about 50-100% by weight microwaveable candlewax ingredients.

26. The candle refill kit of claim 24, wherein the microwaveable candlewax composition is in the disposable microwaveable container.

27. The candle refill kit of claim 24, further comprising a packet, wherein the microwaveable candlewax composition is in the packet.

28. The candle refill kit of claim 26, wherein coloring and/or scenting agents are provided in one or more separate packets.

29. The candle refill kit of claim 26, wherein the microwaveable container comprises a cup and a cover having a plurality of openings.

30. The candle refill kit of claim 24, further comprising a color-changing strip which changes color at an elevated temperature.

31. A method of making a candle, comprising the steps of:
providing a microwaveable container;
providing a microwaveable candlewax composition;
microwave heating the microwaveable candlewax composition in the microwaveable container;
pouring the heated microwaveable candlewax composition from the microwaveable container into a candle mold or candle container; and
cooling the candlewax composition or permitting it to cool.

32. The method of claim 31, wherein the candlewax composition is microwave heated to at least about 50° C.

33. The method of claim 31, wherein the candlewax composition is microwave heated to about 55-80° C.

34. The method of claim 31, wherein the candlewax composition is provided in the microwaveable container.

35. The method of claim 34, further comprising the step of adding a scenting agent and/or coloring agent to the heated microwaveable candlewax composition.

36. The method of claim 31, wherein the candlewax composition comprises a lipid-based wax.
